(19) United States
(12) Patent Application Publication
(10) Pub. No.: US 2016/0366822 A1
(43) Pub. Date: Dec. 22, 2016

(54) Base Cutter Blade

(71) Applicants: Don Rillo Teko, Baton Rouge, LA (US); Jared Cormier, Baton Rouge, LA (US)

(72) Inventors: Don Rillo Teko, Baton Rouge, LA (US); Jared Cormier, Baton Rouge, LA (US)

(21) Appl. No.: 14/740,976

(22) Filed: Jun. 16, 2015

(51) Int. Cl. A01D 45/10; A01D 45/00

(52) U.S. Cl. CPC A01D 45/10; A01D 45/00

(57) ABSTRACT

An improved base cutter blade suited for use in a sugar cane harvester. The preferred improved blade has a generally elongated flat body with opposing longitudinal edges. A removable, replaceable knife is also provided. The knife is made to releasably engage the leading edge of the body. Grooves are preferably centrally positioned in both edges of the body. In the preferred configuration, the knife dovetails with the portion of the groove corresponding to the leading edge of the body. Thus, the knife will perform most of the cutting work and bear the brunt of the wear suffered by the blade. When the knife becomes dull, only the knife need be replaced, which can be done quickly. This will save a significant amount of time during harvest operations. It will also reduce the amount of material that is consumed in the form of worn out blades.

### BACKGROUND OF THE INVENTION

Field of the Invention

The invention relates to blades in general and sugar cane base cutter blades in particular.

Prior Art

Sugar cane is the most widely produced crop in the world, with more than 54 million acres harvested globally in 2007. Much of that cane is harvested using automated harvesters such as that disclosed in Deere & Co.'s U.S. Pat. No. 8,578,688, which is hereby incorporated by reference. As illustrated in FIG. 2 of the '688 Patent, the cane is fed into a base cutter assembly that includes a plurality of rotating blades. These blades are usually made of carbon steel, and they are designed to cut the cane near the ground. In addition to the cane, the blades will encounter dirt and debris in the fields—an inevitability given the need to cut the cane low to the ground. Use of the blades will dull the blades. This happens relatively quickly—so quickly, that blades typically must be changed every six hours. This entails stopping the harvester for up to an hour while all blades are removed and replaced. The blades can usually be reversed once, but this does not save time as reversal requires complete removal of the blades. Used blades are usually discarded when replaced, resulting in a significant waste of materials.

Conducting harvesting operations as quickly as possible is important. In much of the world, sugar cane is burned prior to harvesting. Burning expedites harvesting and reduces the amount of low sugar content vegetation that must be handled, shipped, and processed. However, sucrose in the cane will deteriorate quickly after the cane is burned.

Of course, farmers do not intentionally burn more cane than they can harvest promptly. However, equipment breakdowns and adverse weather conditions can prevent good matches between the anticipated rate of harvest and reality. Moreover, in areas where freezing temperatures near harvest are a concern, cane needs to be harvested as soon as it is ready, as sucrose deteriorates rapidly in freeze killed cane as well.

For all of the foregoing reasons, harvest usually runs 24 hours a day until completed. Expediting the rate of harvest when everything is working reduces the chances that the unexpected will have a significant adverse effect on crop yields. However, under current conditions, “everything working” includes shutting down for an hour to change blades every six hours. This represents a scheduled loss of over 10 percent of the harvesting day. In view of the foregoing, a harvester blade meeting the following objectives is desired.

### OBJECTS OF THE INVENTION

It is an object of the invention to provide a harvester blade that does not dull as readily as conventional blades.

It is a further object of the invention to provide a harvester blade that may be changed relatively quickly when the blade becomes dull.

It is a yet another object of the invention to provide a harvester blade that minimizes the material to be discarded or recycled when blades are changed.

It is a still further object of the invention to provide a harvester blade that will expedite the rate at which sugar cane is harvested.

It is yet another object of the invention to minimize the amount of time harvesters are scheduled to be down during harvest.

### SUMMARY OF THE INVENTION

An improved base cutter blade suited for use in a sugar cane harvester is disclosed. The preferred embodiment of the improved blade comprises a generally elongated flat body having opposing longitudinal edges. A removable, replaceable knife is also provided. The knife is configured to releasably engage the leading edge of the body. Grooves are preferably centrally positioned in both edges of the body. In the preferred embodiment, the knife is configured to dovetail with the portion of the groove corresponding to the leading edge of the body. Thus, when the knife is in place, the knife will perform most of the cutting work and bear the brunt of the wear suffered by the blade. When the knife becomes dull, only the knife need be replaced, which can be done quickly. This will save a significant amount of time during harvest operations. It will also reduce the amount of material that is consumed in the form of worn out blades. By utilizing harder, more resilient metals for the knife and the body of the blade, the life of both may be extended even further.

### BRIEF DESCRIPTION OF THE DRAWINGS

FIG. 1 is an illustration of a mechanical sugar cane harvester in operation.

FIG. 2 is a perspective view of a prior art sugar cane base cutter plate pair.

FIG. 3 is bottom view of a prior art sugar cane base cutter plate pair.

FIG. 4 is a perspective view of a prior art sugar cane base cutter blade.

FIG. 5 is a perspective view of an embodiment of the improved base cutter body.

FIG. 6 is a perspective view of an embodiment of the improved base cutter knife.

FIG. 7 is an exploded view of an embodiment of the improved base cutter body, knife, and pins.

FIG. 8 is a perspective view of an assembled embodiment of the improved base cutter body, knife, and pins.

FIG. 9 is a bottom view of a sugar cane base cutter plate pair using the embodiment of the improved base cutter blades illustrated in FIG. 8. The “F” in the figure indicates the location of the front of the harvester.

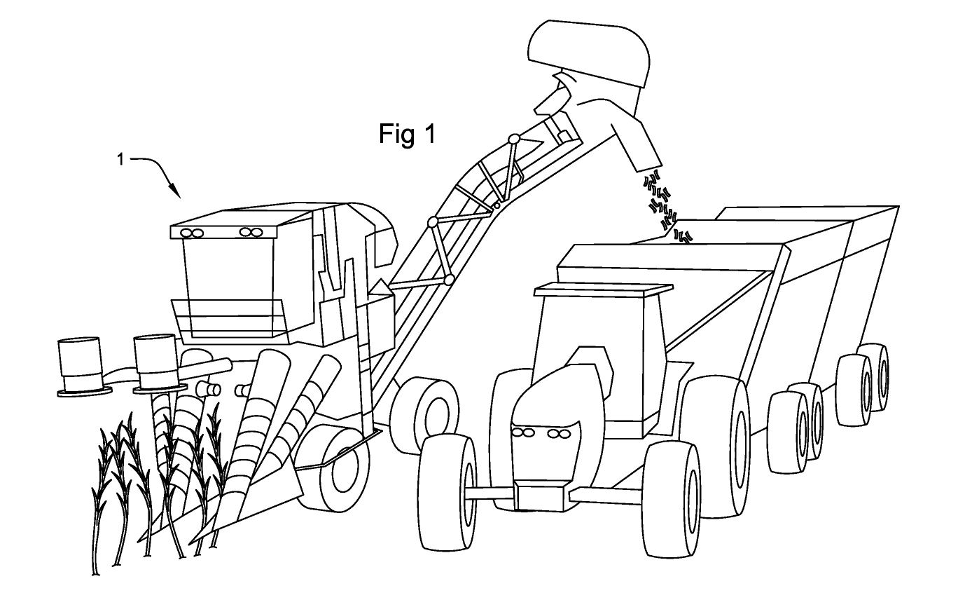

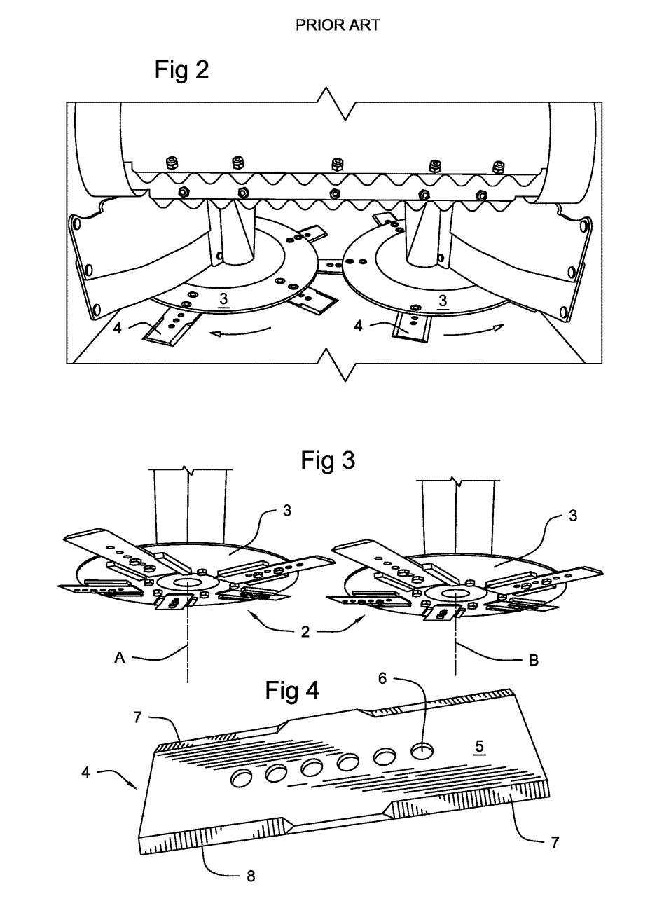

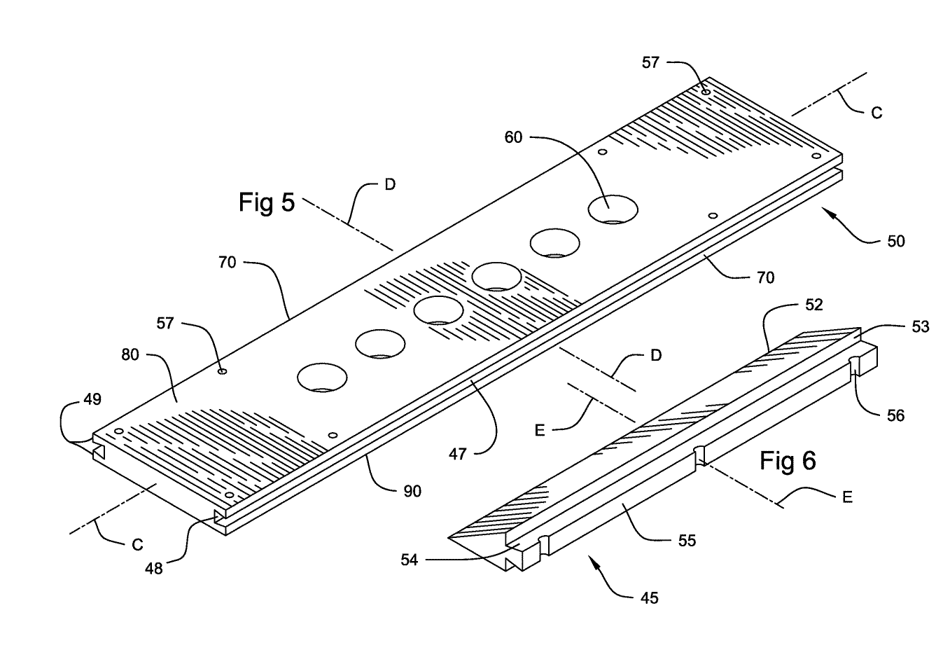

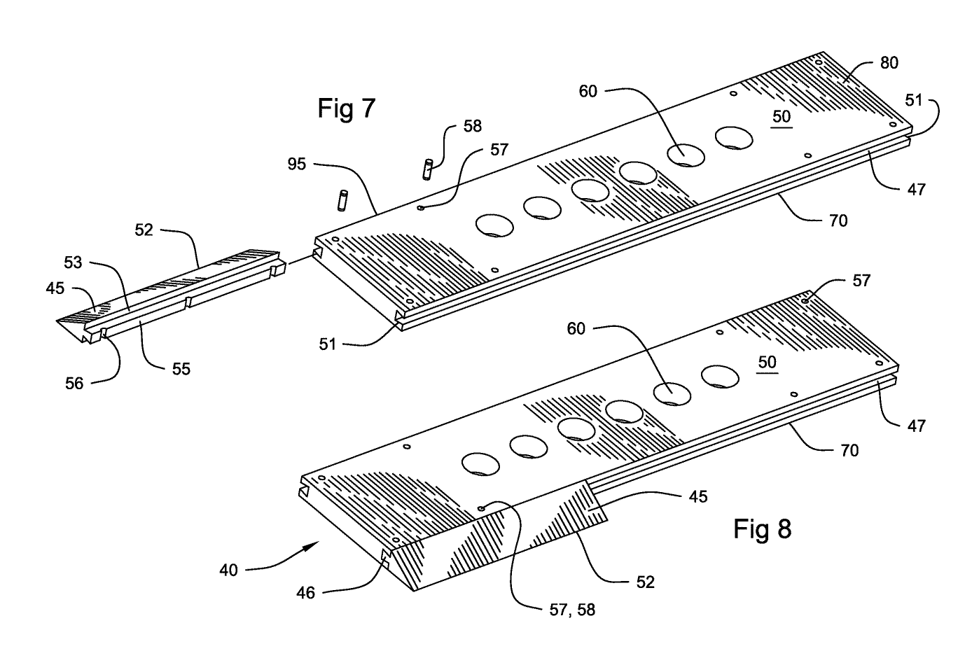

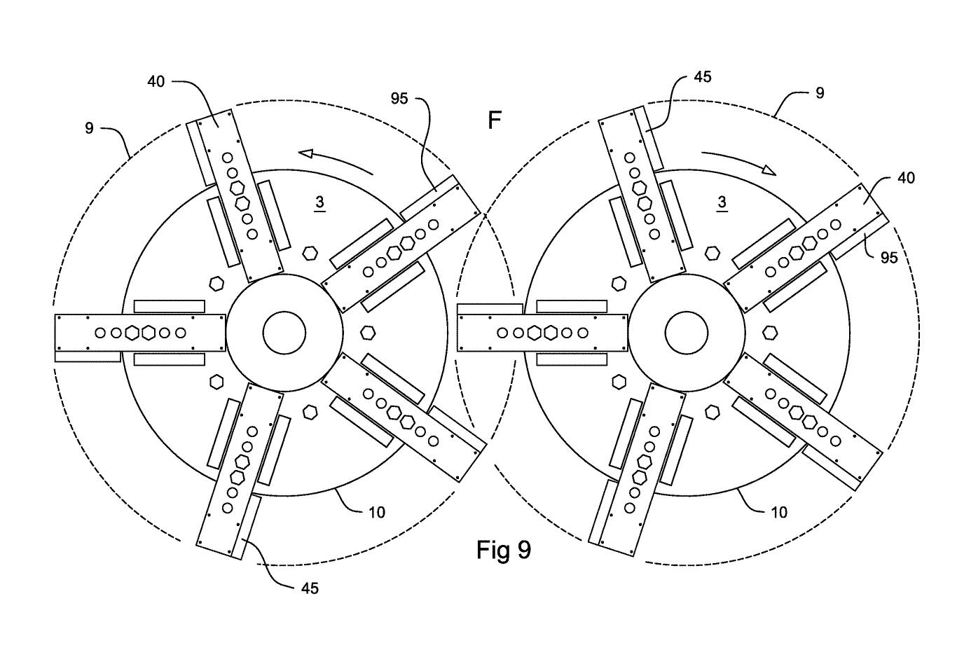

### DETAILED DESCRIPTION OF THE PREFERRED EMBODIMENT OF THE INVENTION

The invention pertains to base cutter blades for sugar cane harvesters. Harvesters 1 typically include one or more pairs 2 of cutting plates 3. Plates 3 are preferably approximately round and each configured to rotate about separate, substantially parallel axes A, B. Plates 3 typically rotate in opposite directions. Each plate 3 is provided with a plurality of base cutter blades 4. Prior art base cutter blades 4 are typically elongated metal bars 5 with a plurality of mounting holes 6 centrally positioned in bars 5. The opposing longitudinal edges 7 of bars 5 are beveled to create a knife edge 8. Base cutter blades 4 are positioned on plates 3 so that blades 4 extend radially from plates 3. When plates 3 are rotated the ends of blades 4 define a circumference 9 that is greater than the circumference 10 of plates 3. Plates 3 are positioned relative to each other so that circumferences 9 of adjacent plates 3 overlap. However, blades 4 are offset relative to each other so that the blades 4 on one plate 3 will not contact their counterpart blades 4 on opposing plate 3 as long as plates 3 rotate at the same rate. Plates 3 may also be slightly offset vertically to ensure blades 4 do not contact during rotation.

The foregoing configuration will sever all cane stalks that come within either circumference 9. However, high speed rotation of base cutter blades 4 will bring them into contact with dirt, rocks, general debris, as well as the cane stalks, which when mature are not exactly tender. Blades 4 are typically mild carbon steel and dull quickly under the foregoing conditions. When dull, blades 4 may be reversed once. Plurality of mounting holes 6 are sized and positioned to facilitate reversal of blades 4 while allowing operators to ensure that the distance blades 4 extend from plates 3 remains constant. However, reversal of blades 4 requires harvester 1 to be stopped and all blades 4 to be removed, reversed, and reinserted. As noted above, this is very time consuming.

Reversing blades 4 converts what was a trailing, shielded edge into the leading edge of blade 4. When the newly exposed edge dulls, the entire prior art blade 4 must be removed and replaced. Removal proceeds in the same manner described above, except instead of reversing blade 4, a new blade 4 is installed. Both processes are equally time intensive.

In theory, blades 4 could be re-sharpened and reused. In practice, blades 4 are usually so worn that re-sharpening is not practical. As a result, blades 4 are usually discarded or recycled.

The preferred embodiment of the invention comprises an improved base cutter blade 40. Like conventional blade 4, improved blade 40 is preferably an elongated metal body 50 having an upper face 80 opposite a lower face 90 and opposing longitudinal edges 70 extending between faces 80, 90. Body 50 is preferably provided with a plurality of centrally located mounting holes 60. Unlike conventional blades 4, edges 70 are not beveled to a knife edge. Rather, edges 70 are configured to receive a releasible and replaceable knife 45, In the preferred embodiment, edges 70 and knife 45 are configured to mate with one another using a dovetail 46. In the preferred embodiment, edges 70 are provided with a centrally positioned groove 47 that preferably runs the length of edge 70. Groove 47 has a base 48 and a mouth 49. Base 48 is preferably wider than mouth 49. At least one and preferably both ends 51 of groove 47 are co-terminal with edge 70 and are preferably open.

In the preferred embodiment, knife 45 has a cutting edge 52 opposite a base 53. A tail 54 extends from base 53. Tail 54 should match groove 47, being slightly narrower where tail 54 joins base 53 and wider at the distal end 55 of tail 54. By inserting tail 54 into groove 47 at open end 51, knife 45 may be joined with body 50. Tail 54 is preferably provided with a plurality of channels 56 which may pass through tail 54 or create slots in distal end 55 of tail 54. Body 50 is provided with a plurality of apertures 57 that open onto groove 47 and align with channels 56 in tail 54 when tail 54 has been inserted into groove 47. A plurality of pins 58 are preferably provided. Pins 58 are sized to mate with apertures 57 and channels 56 and are preferably coiled or slotted spring pins. By inserting pins 58 into apertures 57 and channels 56, knife 45 and tail 54 may be secured to body 50 and groove 47. In particular, the dovetail connection between tail 54 and groove 47 will secure knife 45 to body 50 in directions perpendicular to edge 70 and pins 58 will secure knife 45 is the direction parallel to edge 70—i.e., pins 58 will prevent knife 45 from sliding within groove 47.

When knives 45 become dull, rather than removing and changing blades 40, pins 58 may be removed and only knives 45 need be changed. A task that previously required an hour can be reduced to 10 to 15 minutes.

In the preferred embodiment, knives 45 will be about four inches long or slightly longer. During use, most of the wear will be confined to the forward two inches of knife 45. By positioning channels 56 properly, knife 45 may be reversed—turned 180 degrees about axis E—so that its rearward end 96 becomes the forward end 97. When it is desired that knife 45 be reversible, knife 45 will preferably be generally symmetrical about axis E. Making knives 45 reversible will effectively double the life of each knife 45 and minimize the waste associated with blades 40.

In the preferred embodiment, groove 47 extends the length of both edges 70. However, it will be appreciated that groove 47 could be limited to the length of knife 45. Groove 47 could also be provided on only one edge of body 50. There are advantages to positioning grooves 47 on both sides of body 50. It will be appreciated that the leading edge 95 of body 50—where knife 45 is positioned—will be subjected to the majority of wear. However, because of the proximity of plate 3 and blade 40 to the ground and the general operating conditions to which blade 40 will be exposed, some wear on edge 70 is inevitable. If groove 47 becomes worn so that a new knife 45 cannot be readily inserted or secured, body 50 may be removed and reversed in the same fashion as prior art blades 4, which will allow the opposite and previously sheltered end of groove 47 to become leading edge 95 of body 50. This portion of edge 70 should be relatively undamaged and able to receive knife 45. However, reversal is only practical if grooves 47 are on both edges 70.

By positioning grooves 47 along the longitudinal center of edges 70, it will be appreciated that body 50 may be rotated about two of its axes C, D to present any of the four corners of body 50 as the leading edge of body 50. That is, body 50 is fully reversible. In each position, body 50 can receive knife 45 within which ever corner of edge 70 is the leading edge.

The foregoing configuration will significantly enhance the life of blades 40. Knives 45 will bear the brunt of the wear to which blades 40 will be exposed. Knives 45 may be easily and quickly reversed or replaced. However, when the leading groove 47 of body 50 becomes damaged, body 50 may flipped at least once and, depending upon the nature and extent of the wear, as many as three times before body 50 must be replaced.

All of the foregoing advantages may be achieved utilizing bodies 50 and knives 45 made of carbon steel—the same materials from which prior art blades 4 are commonly made. However, the life of blades 50 and knives 45 maybe extended significantly by using higher quality metals for each component. The improved design facilitates this, as the part taking the most abuse, knife 45, is relatively small. Using higher quality and correspondingly more expensive material is more economically feasible when only a small component is discarded when replacement becomes necessary.

In the preferred embodiment, knife 45 is made from CPM 10V (AISI A11) tool steel. The preferred alloy is manufactured via Crucible Particle Metallurgy^{TM} by Crucible Industries, Inc. It includes high carbon and vanadium to provide good wear resistance, toughness, and strength. Knife 45 is preferably formed from a solid block of metal via computerized numerical control (CNC) machining Once knife 45 is formed, it is preferably age hardened to increase its hardness to at least about 60 on the HRC Rockwell scale. The resulting knife 45 can be expected to operate for at least about 24 hours under extreme harvest conditions before a new knife 45 is required.

Body 50 is preferably made of a high strength alloy capable of withstanding cyclic loading of the kind commonly encountered during harvest. Suitable alloys include AISI 4130 steel. Body 50 is also preferably cut from a solid block of metal using CNC machining Once formed, body 50 will preferably be age hardened until its Rockwell HRC number is at least about 45. The resulting body 50 will hold up well under harvest conditions commonly faced by harvester 1.

In operation, blades 40, including knives 45, will be installed on plates 3. Harvester 1 will be operated in the same manner as it was with prior art base cutter blades 4. When knives 45 become dull, harvester 1 will be stopped, pins 58 will be removed, and knives 45 will be reversed or replaced. This will be much faster than replacing blades 4. Once knives 45 have been reversed or new knives 45 have been installed, harvest operations may resume.

Although the invention has been described in the context of sugar cane base cutter blades, it will be appreciated that base cutter blades 40 could be used to cut any crop, weed, or other vegetation. These and other improvements to the base cutter blades will be apparent to those of skill in the art from the foregoing disclosure and drawings and are intended to be encompassed by the scope and spirit of the following claims.

1. A base cutter assembly comprising a plate configured to rotate about a central axis and a plurality of base cutter blades extending radially from said plate, at least one of said blades comprising:
an elongated solid body having an upper surface opposite a lower surface and a pair of opposing longitudinal edges extending between said upper surface and said lower surface wherein one of said edges comprises a leading edge of said blade when said plate is rotated about said axis, said leading edge comprising a groove having a base and a mouth; and
a knife configured to releasably engage said groove of said leading edge of said blade, whereby said knife may be removed and replaced without replacing said body.

2. A base cutter assembly according to claim 1 wherein said groove comprises a channel cut into said leading edge of said solid body.

3. A base cutter assembly according to claim 2 wherein said knife has a cutting edge opposite a base.

4. A base cutter assembly according to claim 3 wherein said knife further comprises a tail extending from said base.

5. A base cutter assembly according to claim 4 wherein said said knife and said leading edge are configured to engage one another in a dovetail

6. A base cutter assembly according to claim 5 wherein said groove is sized to receive said tail.

7. A base cutter assembly according to claim 4 wherein said pair of opposing edges each comprise a groove having a base and a mouth.

8. A base cutter assembly according to claim 7 wherein each said groove is sized to receive said tail.

9. A base cutter assembly according to claim 8 wherein each said groove is positioned in about the longitudinal center of each edge.

10. A base cutter assembly according to claim 1 wherein said knife is age hardened to at least about 60 on the HRC Rockwell scale.

11. A base cutter assembly according to claim 10 wherein said body is age hardened to at least about 45 on the HRC Rockwell scale.

12. A base cutter assembly according to claim 1 wherein said body is further provided with a plurality of mounting holes.

13. A base cutter assembly according to claim 1 comprising at least two plates, each said plate configured to rotate about separate, substantially parallel central axes and a plurality of base cutter blades extending radially from each said plate.

14. A base cutter assembly according to claim 13 where said at least two plates are configured to rotate in opposite directions.

15. A sugar cane harvester having a mechanism for cutting cane wherein the improvement comprises a base cutter assembly according to claim 14.

16. A base cutter assembly according to claim 1 where said knife is reversible.
